(19) United States
(12) Patent Application Publication
(10) Pub. No.: US 2009/0288053 A1
(43) Pub. Date: Nov. 19, 2009

(54) METHODS OF CELL ASSOCIATION FOR AUTOMATED DISTANCE MANAGEMENT IN INTEGRATED CIRCUIT DESIGN

(76) Inventors: Jeffrey S. Brown, Fort Collins, CO (US); Alan L. Ilolesovsky, Fort Collins, CO (US); Mark F. Turner, Longmont, CO (US)

Correspondence Address: Duft Bornsen & Fishman LLP, 1526 Spruce Street, Suite 302, Boulder County, CO, 80302, US

(21) Appl. No.: 12/119,893

(22) Filed: May 13, 2008

(51) Int. Cl. G06F 17/50

(52) U.S. Cl. 716/10

(57) ABSTRACT

Associated methods and a computer program product are disclosed for modifying a design of an integrated circuit. Properties are assigned to cells in an integrated circuit design. The properties include a location constraint property and a timing constraint property. When a cell is moved and one or more properties are not in compliance, other cells are moved to restore the non-compliant properties to compliance.

### BACKGROUND OF THE INVENTION

1. Field of the Invention

The invention is related to the field of integrated circuit design, and in particular, relates to automated distance management of associated cells in the design of an integrated circuit.

2. Discussion of Related Art

In integrated circuit design, a number of standard logic cells (e.g., AND, OR, XOR, XNOR, inverters, flip flops, clocks, etc.) are used to represent some of the basic building blocks of an integrated circuit design. Much more complex standard logic cells include adders, multipliers, processors, transmission circuits, etc. An integrated circuit designer uses computer aided engineering (CAE) tools to initially design the circuits. After the circuits have been designed, the cells are placed in a physical relationship to each other in a representation of the integrated circuit using the CAE tools. When signals are transmitted between the cells in the integrated circuit, the physical relationship between each of the cells defines a timing relationship between the cells. For example, cells which are farther apart physically on the integrated circuit require a longer time between transmission from one cell and reception by another cell. Also, when one cell on the integrated circuit (e.g., a clock source) is required to transmit signals to a number of clock receivers, it is important that the physical distances between the clock source and each clock receivers controlled. Differences in the physical distance will cause the clock signal sent by the clock source to arrive at the clock receivers at different times. This timing difference causes a clock skew, or in other words, a slight variation in the reception of the clock signal at a clock receiver relative to other clock receivers. In many circuit designs, such as synchronous circuits (i.e., circuits which share a common clock for circuit state changes), it is important to ensure that any clock source and clock receiver circuits minimize the clock skew between the clock source and each of the clock receivers in order to prevent undesired circuit behavior.

One method to reduce clock skew between clock sources and clock receivers is to place the cells in a hard macro A hard macro contains a number of standard logic cells in a fixed relationship (e.g., a clock source and a plurality of clock receivers) which can then be placed as a cell normally would. Once in hard macro form, however, this collection of standard logic cells is fixed in relative location to each other, and is placed as an atomic unit. Because this plurality of standard logic cells is in hard macro form, any automatic placement of cells, manual placement of cells, or routing performed by the CAE tools can only move the hard macro as an atomic unit.

### SUMMARY OF THE INVENTION

The present invention improves upon the present state of the art in integrated circuit design by assigning properties to related cells in an integrated circuit design. When a cell is moved and the properties assigned to the related cells indicates that one or more properties are no longer in compliance, an indication is given which of the remaining related cells to move in accordance with the properties to restore the non-compliant properties.

In one aspect hereof a method of modifying an integrated circuit design is provided. The method includes assigning a set of properties to each of a plurality of cells in the integrated circuit design, where the properties include a location constraint and a timing constraint. After moving a cell, an indication is made of the remaining cells to move in accordance with the set of properties. The integrated circuit design is then generated in response to the movement of the cells.

Another aspect hereof provides a second method of modifying an integrated circuit design. The second method includes assigning a set of properties to a signal source and a plurality of signal receivers, where the set of properties includes a distance between the signal source and the plurality of signal receivers. The set of properties further includes a distance between each of the plurality of signal receivers and a geometric shape defining an initial relative placement of the signal source and the plurality of signal receivers. In response to moving at least one of the signal source and the plurality of signal receivers to modify the initial relative placement, the remaining cells are automatically moved in accordance with the set of properties to restore the initial placement. The modified integrated circuit design is then generated in response to the automatic cell movement.

The invention may include other exemplary embodiments described below.

### BRIEF DESCRIPTION OF THE DRAWINGS

The same reference number represents the same element or same type of element on all drawings.

FIG. 1 is a flowchart of an exemplary method for modifying the design of an integrated circuit in an embodiment of the invention.

FIG. 2 is a plurality of cells in a line geometric shape modified according to the method of FIG. 1.

FIG. 3A is a plurality of cells in a box geometric shape modified according to the method of FIG. 1.

FIG. 3B is a plurality of cells in a box geometric shape modified according to the method of FIG. 1.

FIG. 4A is an illustration of a plurality of cells in an asymmetric star geometric shape modified according to the method of FIG. 1

FIG. 4B is an illustration of a plurality of cells in an asymmetric star geometric shape modified according to the method of FIG. 1

FIG. 5 is a flowchart describing an exemplary method for modifying the design of an integrated circuit in an embodiment of the invention.

FIG. 6 is an illustration of a plurality of cells in a cross geometric shape modified according to the method of FIG. 6.

FIG. 7 is a detailed view of a step 502 of the method of FIG. 6 in an embodiment of the invention.

FIG. 8 is an illustration of a computer system for performing at least one of the method of FIG. 1 and the method of FIG. 6 in an embodiment of the invention.

### DETAILED DESCRIPTION OF THE DRAWINGS

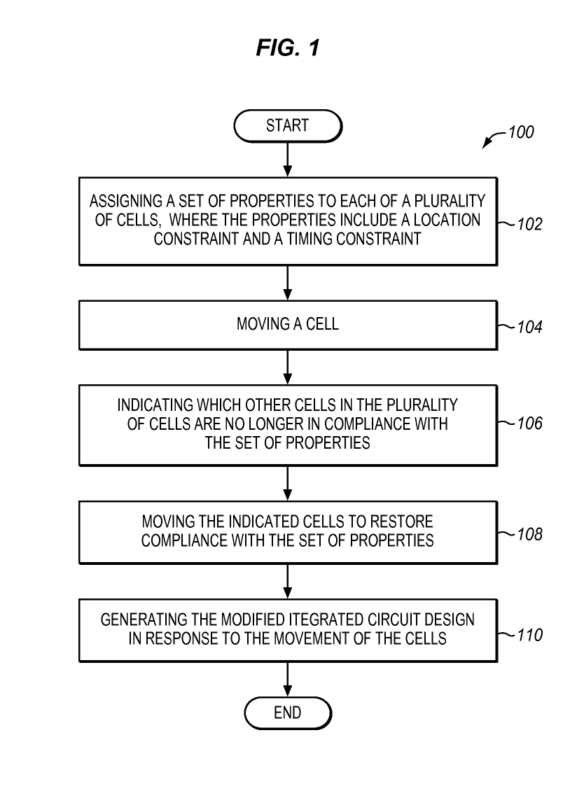

FIGS. 1-8 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 is a flowchart of an exemplary method 100 for modifying the design of an integrated circuit in an embodiment of the invention. The steps of method 100 are not all inclusive and may include other steps not shown. Step 102 of method 100 includes assigning a set of properties to each of a plurality of cells, where the properties include a location constraint and a timing constraint. When designing an integrated circuit using a CAE tool, the designer assigns various properties to cells in the design. For example, the designer may assign location properties to a number of cells in the design, which define either the relative or absolute locations of specific cells to other cells in the design. It may also be desirable when assigning absolute or relative location properties to use that information to generate a specific geometric shape for the number of cells. When the location information places the cells in the design in specific geometric shapes, the physical relationships of the cells in the design are more easily related to a user. Some common geometric shapes include a star shape, a box shape, a cross shape, and a line shape, although there are an infinite number of geometric shapes possible. The designer may also assign a timing constraint to a cell or a number of cells in the design. For example, the designer may assign a timing constraint to two selected cells in the design to ensure that specific signals transmitted by one cell are received by the other cell within a specific time.

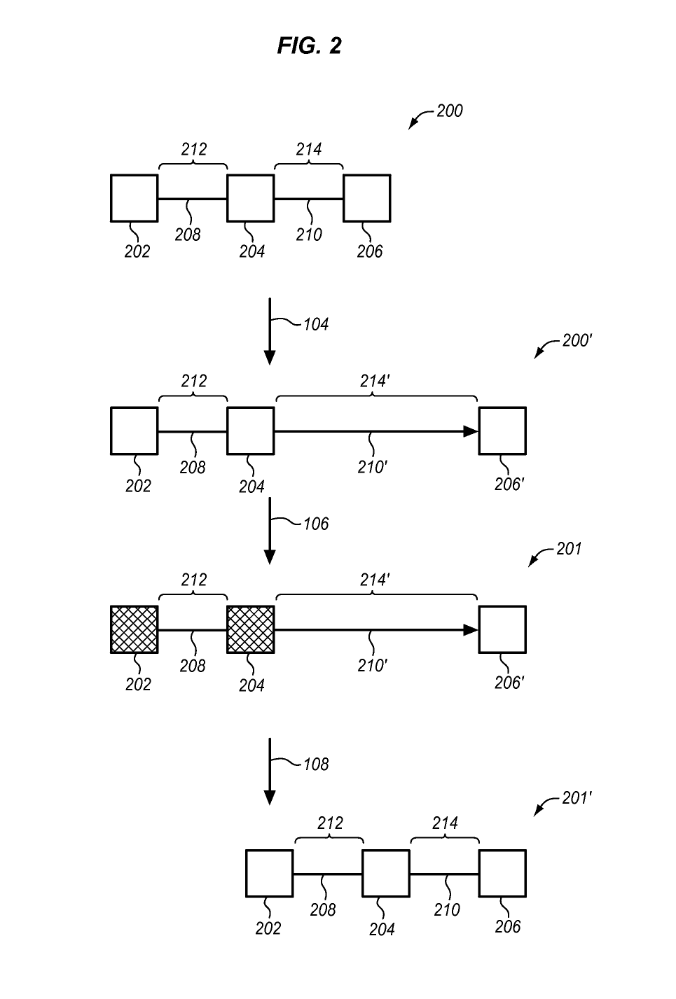

FIG. 2 is a plurality of cells in line geometric shape 200, modified line geometric shape 200′, indicated line geometric shape 201 and restored line geometric shape 201′ modified according to the method 100 of FIG. 1. Line geometric shape 200 includes cells 202-206. Line geometric shape 200 further includes signal paths 208 and 210, which indicate an electrical connection between cells 202-206. As indicated in step 102 of method 100 (see FIG. 1), a number of properties may be assigned to a plurality of cells. For example, cells 202-206 are assigned a location property such that the spacing 212 and 214 between cell 204 and cells 202 and 206, respectively, is the same. The location property may also include relative location information between cell 204 and cells 202 and 206 such that spacing 212 between cell 204 and cell 202 is 2×, 3×, or some other predetermined relationship as compared to spacing 214 between cell 204 and cell 206. Step 102 of method 100 also assigns a timing constraint property for cells 202-206. When assigning a timing constraint property to cells 202-206, specific timing relationships between cells are created. For example, signals transmitted by cell 204 to cells 206 and 202 along signal paths 210 and 208, respectively, have a predetermined timing relationship based on the timing constraint property assigned to cells 202-206. This timing constraint property is assigned such that signals transmitted from cell 204 along signal paths 208 and 210 arrive at the same time at cells 202 and 206, respectively. The timing constraint property assigned to cells 202-206 may also create different timing relationships between cells 202-206, including half phase or quarter phase timing relationships between signals transmitted along signal paths 208 and 210.

Step 104 of method 100 includes moving a cell. There are a number of ways a cell may move in an integrated circuit design. A user may select and move a cell manually, or a cell may be moved automatically from the CAE tool in response to some requirement. When a moved cell has assigned properties, the movement of the cell may alter the location constraint and/or the timing constraint assigned to the cell. For example, referring to FIG. 2, modified line geometric shape 200′ is the result of performing step 104 of method 100 on line geometric shape 200. Cell 206 has been moved to a new location indicated by cell 206′. The movement of cell 206 to cell 206′ results in the spacing 214 increasing to spacing 214′, and signal path 210 increasing to signal path 210′.

Step 106 of method 100 includes indicating which other cells in the plurality of cells are no longer in compliance with the set of properties. Referring to FIG. 2, indicated line geometric shape 201 is the result of step 106 of method 100. Cells 202 and 204 are indicated as being non-compliant with respect to the set of properties assigned in step 102 of method 100. When spacing 214 changes to spacing 214′, the location constraint properties assigned in step 102 of method 100 are no longer in compliance. Specifically, the spacing between cell 204 and cell 206 is not equal to the spacing between cell 204 and cell 202. Also, when signal path 210 changes to signal path 210′, the timing constraint properties assigned in step 102 of method 100 are no longer in compliance. Specifically, the timing relationship between cell 204 and cell 206 is different than the timing relationship between cell 204 and cell 202. This is evident by the difference in signal path lengths 208 and 210′.

Step 108 of method 100 includes moving the indicated cells to restore compliance with the set of properties. This movement may be performed manually or automatically. Referring to FIG. 2, restored line geometric shape 201′ is the result of step 108 of method 100. Cells 202 and 204 are moved in accordance with the set of properties assigned in step 102 of method 100 to restore the assigned properties to compliance. Spacing 214 is restored to compliance based on the location constraint properties assigned in step 102 of method 100. Signal paths 208 and 210 are now restored to compliance based on the timing constraint properties assigned in step 102 of method 100. Step 110 of method 100 includes generating a modified integrated circuit design in response to the movement of the cell 202 and 204 in step 104 of method 100.

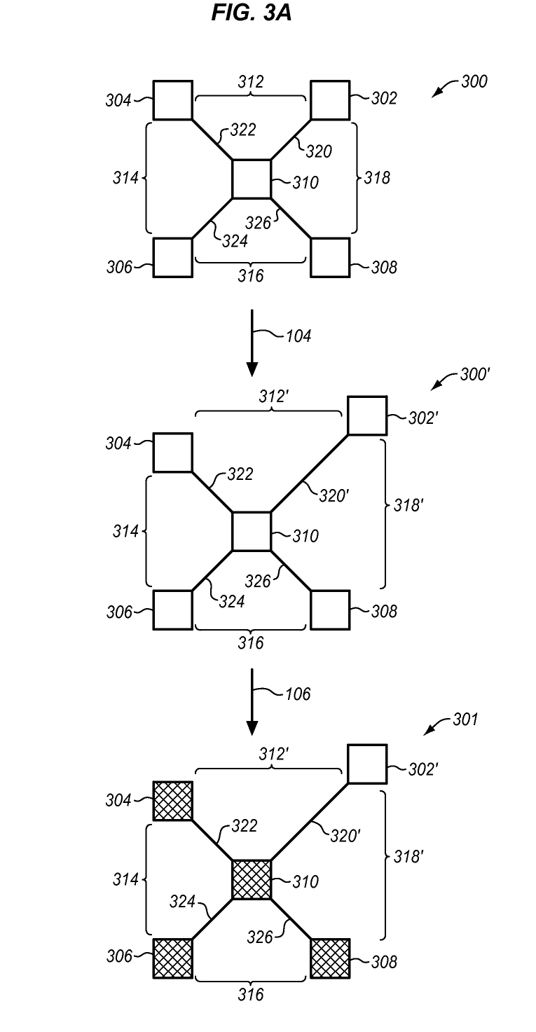

FIG. 3A and FIG. 3B are a plurality of cells 302-310 in box geometric shape 300, modified box geometric shape 300′, indicated box geometric shape 301 and restored box geometric shape 301′ modified according to method 100 of FIG. 1. Box geometric shape 300 includes cells 302-310, signal paths 320-326, and spacing 312-318. Along with assigning location constraint properties and timing constraint properties in step 102 of method 100, a group identifier property may also be assigned. When a plurality of cells in an integrated circuit design are assigned a common group identifier property, relationships between the grouped cells is possible. For example, box geometric shape 300 has cells 302-310 assigned to a common group identifier. The common group identifier assigned to cells 302-310 allows other relationships to be assigned to cells 302-310, including, but not necessarily limited to, moving cells 302-310 as a group, assigning location constraint properties to cells 302-310 as a group, or timing constraint properties to cells 302-310 as a group. Along with relative or absolute location constraint properties assigned in step 102 of method 100 (see FIG. 1), the location constraint may also define a position of cells in a geometric shape, or a position of a cell relative to an identified cell in the geometric shape. For example, cell 310 (see FIG. 3) is assigned to the center position of box geometric shape 300, and cell 304 is also an identified cell in box geometric shape 300. When cell 302 is moved in modified box geometric shape 300′ to the location indicated by cell 302′ in response to step 104 of method 100 (see FIG. 1), the relative location of cell 302′ and cell 304 is no longer in compliance with the location property assigned in step 102 of method 100. Specifically, spacing 312 has changed to spacing 312′. The increase in spacing 312 to spacing 312′ is non compliant with respect to the assigned relative location property. Cells 304-310 are also non-compliant with respect to the assigned geometric shape. Indicated box geometric shape 301 is the result of performing step 106 of method 100. Cells 304-310 have been indicated as being non-compliant with the set of properties assigned to cells 302-310. Restored box geometric shape 301′ is the result after performing step 108 of method 100. The relative location constraint assigned between cells 302′ and 304 as indicated by spacing 312′ is restored, as indicated by spacing 312. The box geometric shape assigned to cells 302-310 has also been restored.

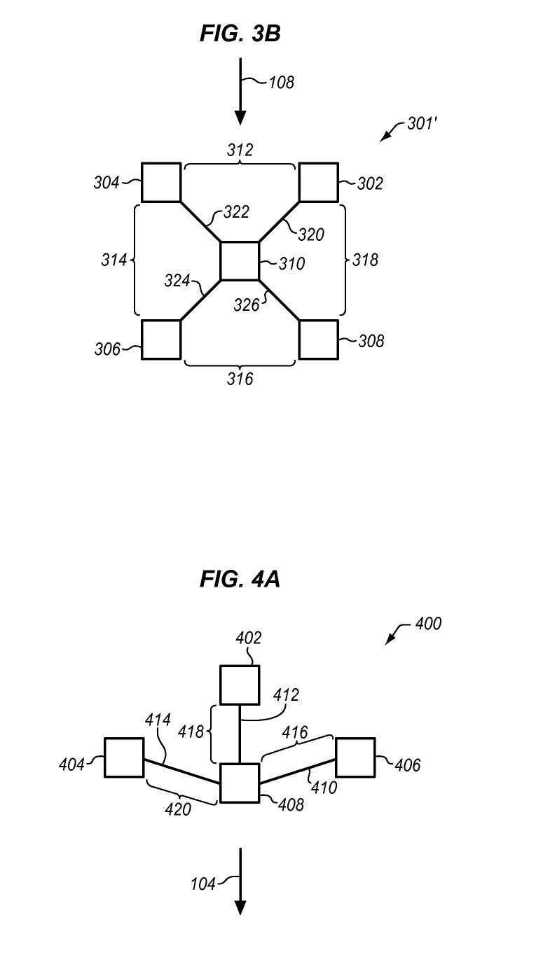

FIG. 4A and FIG. 4B are an illustration of a plurality of cells in an asymmetric geometric shape 400, modified asymmetric geometric shape 400′, indicated asymmetric geometric shape 401 and restored asymmetric geometric shape 401′ modified according to the method of FIG. 1. Asymmetric geometric shape 400 includes cells 402-408, signal paths 410-414, and spacing 416-420. When assigning a location constraint property in step 102 of method 100 (see FIG. 1), the location constraint property may also define a relative location of each of the plurality of cells relative to an identified cell. For example, asymmetric geometric shape 400 includes an identified cell 408 and a plurality of cells 402-406 with a relative location to identified cell 408. Spacing 416-420 indicates the relative spacing of cells 406, 402, and 404, respectively, to identified cell 408. Identified cell 408 is also a clock source, or in other words, identified cell 408 transmits a clock signal along signal paths 410-414 to cells 402-406, respectively. Because identified cell 408 is also a clock source, clock signals transmitted from identified cell 408 and received by the plurality of cells 402-406, may have a relative clock skew between cells 402-406. For example, a timing constraint assigned in step 102 of method 100 (see FIG. 1) for asymmetric geometric shape 400 defines a relative clock skew to be zero between identified cell 408 and cells 406 and 404. A location constraint is also assigned in step 102 of method 100 for asymmetric shape 400 which defines a placement of cell 402 relative to cell 408, but does not include any relative location constraints to cells 404 and 406. Because the assigned timing constraint defines the relative clock skew to be zero, clock signals transmitted from identified cell 408 to both cells 406 and 404 arrive at the same time along identical signal paths 410 and 414. When cell 406 is moved in modified asymmetric geometric shape 400′ to a new location indicated by cell 406′ in response to step 104 of method 100, signal path 410 has increased to signal path 410′, and therefore, signal path 414 is no longer the same as signal path 410′. The relative clock skew constraint assigned in step 102 of method 100 is no longer in compliance due to the movement of cell 406. Indicated asymmetric geometric shape 401 is the result of performing step 106 of method 100. Cell 404 is indicated to be non-compliant with the set of assigned properties. Restored asymmetric geometric shape 401′ is the result after performing step 108 of method 100. In order to bring the relative clock skew assigned in step 102 of method 100 back into compliance, cell 404 is moved to location 404′. This also increases signal path 414 to signal path 414′. Because signal path 410′ is the same as signal path 414′, the relative clock skew is brought back into compliance. Because cell 402's location relative to cell 408 has not changed, its location constraint is still in compliance.

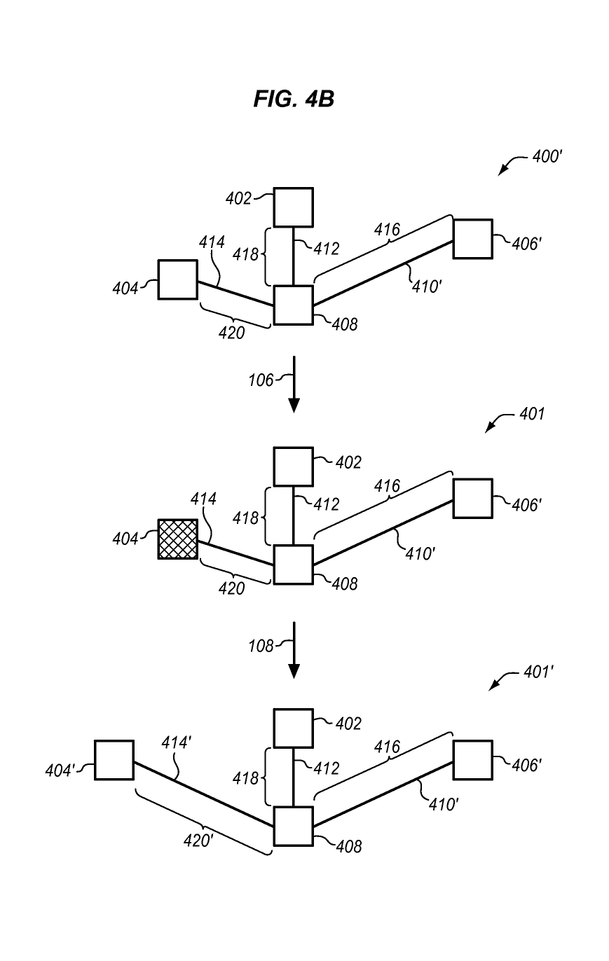

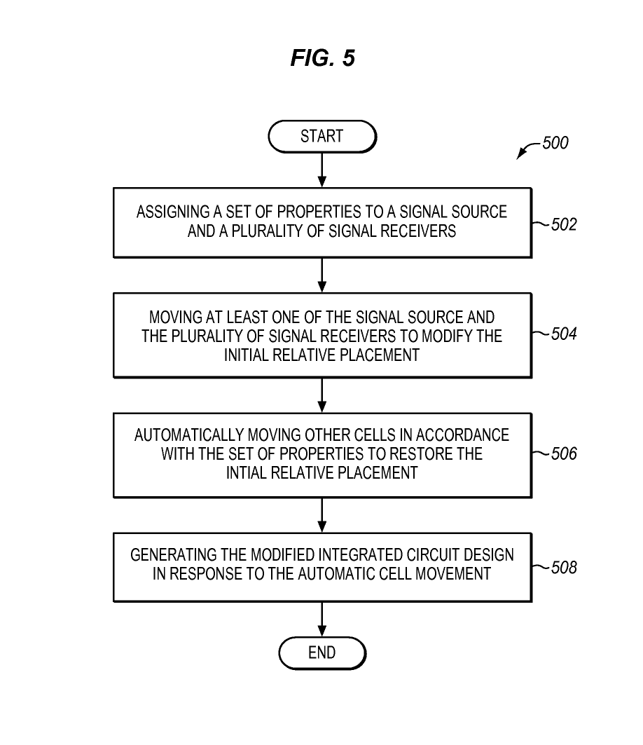

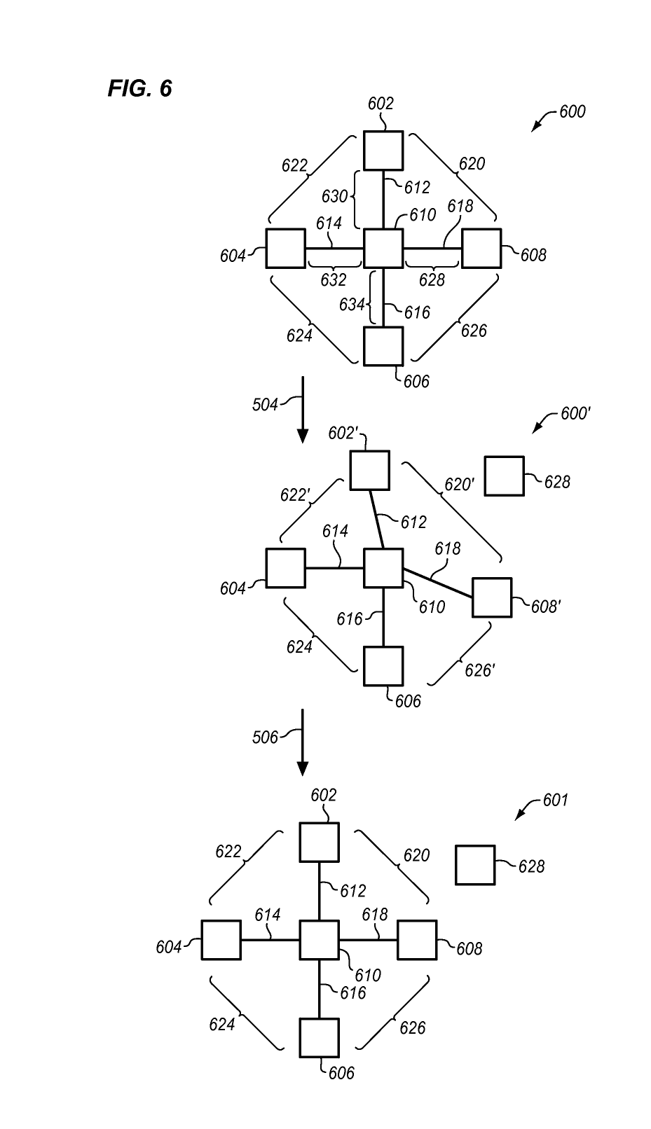

FIG. 5 is a flowchart describing an exemplary method 500 for modifying the design of an integrated circuit in an embodiment of the invention. The steps of the method are not all inclusive and may include other steps not shown. Step 502 includes assigning a set of properties to a signal source and a plurality of signal receivers. FIG. 6 is an illustration of a plurality of cells 602-610 in cross geometric shape 600, modified cross geometric shape 600′, and restored cross geometric shape 601 modified according to the method 500. In FIG. 6, cell 610 is a signal source, and cell 602-608 are signal receivers. FIG. 7 is a detailed view of a step 502 of the method 500 in an embodiment of the invention. Step 502A (see FIG. 7) of method 500 includes assigning a distance between the signal source and the plurality of signal receivers. For example, referring to FIG. 6, spacing 628-634 indicates the assigned distance between signal source 610 and the plurality of signal receivers 602-608. Step 502B (see FIG. 7) of method 500 includes assigning a distance between each of the plurality of signal receivers. For example, referring to FIG. 6, spacing 620-626 indicates the assigned distance between the plurality of signal receivers 602-608. Step 502C (see FIG. 7) of method 500 includes assigning a geometric shape defining an initial relative placement of the signal source and the plurality of signal receivers. For example, referring to FIG. 6, cross geometric shape 600 has been assigned to signal source 610 and signal receivers 602-608 to define an initial relative placement of signal source 610 and signal receivers 602-608.

Step 504 of method 500 includes moving at least one of the signal source and the plurality of signal receivers to modify the initial relative placement. For example, modified cross geometric placement 600′ is the result of performing step 504 of method 500 due to either an automatic or manual placement of cell 628 proximate to signal receiver cells 602′ and 608′. Due to the movement of signal receivers 608 and 602 to new locations indicated by signal receivers 608′ and 602′, spacing 620, 622, and 626 have changed to 620′, 622′, and 626′, respectively. This indicates that the assigned distance between the plurality of signal receivers 602-608 in step 502C (see FIG. 7) is no longer in compliance. Specifically, spacing 620′ between cells 602′ and 608′ is no longer in compliance with respect to the initial spacing 620.

Step 506 of method 500 includes automatically moving other cells in accordance with the set of properties to restore the initial relative placement. Referring to FIG. 5, restored cross geometric shape 601 is the result of performing step 506 of method 500. Signal source 610 and signal receivers 602-608 have been moved to restore the initial relative placement.

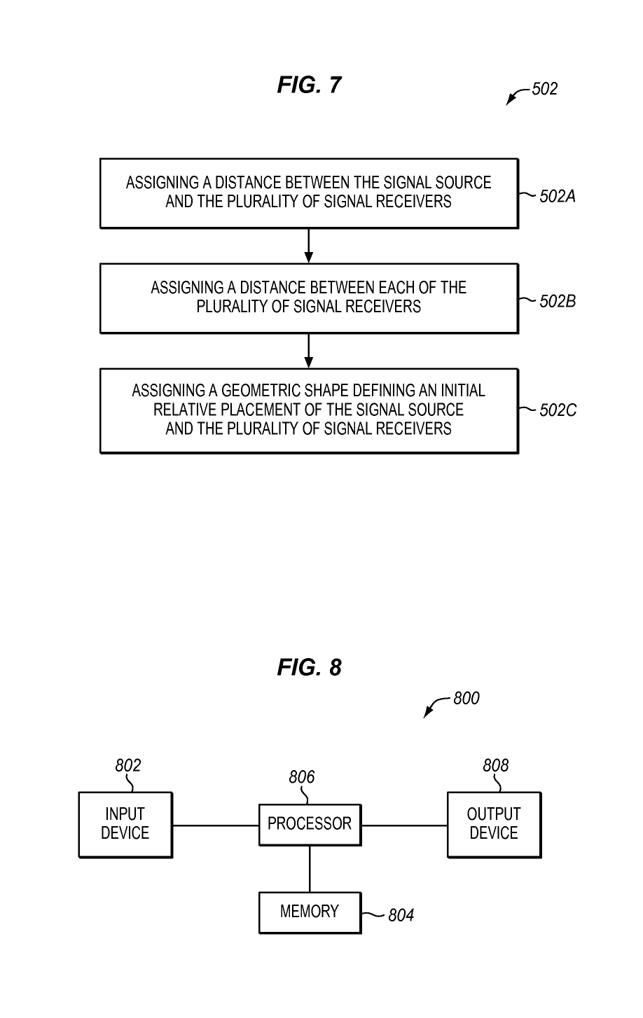

FIG. 8 is a computer system 800 performing at least one of exemplary method 100 of FIG. 1 and exemplary method 500 of FIG. 5 in an embodiment of the invention. FIG. 8 includes input device 802, adapted to receive input from a user. Input device 802 can include a number of devices, including a keyboard, a mouse, or information reception devices operable to receive information from a user. Computer system 800 further includes processor 806 adapted to execute instructions to perform at least one of method 100 and method 500. Computer system 800 further includes memory 804 adapted to store information for processor 806 while executing instructions, and output device 808. Output device 808 may include a monitor, or other display or information transmission device operable to send information to a user.

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A method for modifying a design of an integrated circuit, the method comprising:
assigning a set of properties to each of a plurality of cells of the integrated circuit, wherein the set of properties comprises:
a location constraint; and
a timing constraint;
moving a cell;
indicating which other cells in the plurality of cells are no longer in compliance with the set of properties;
moving the indicated cells to restore compliance with the set of properties; and
generating the modified integrated circuit design responsive to the movement of the cells.

2. The method of claim 1, wherein moving the indicated cells is performed automatically.

3. The method of claim 1, wherein assigning the set of properties further includes assigning a group identifier.

4. The method of claim 1, wherein the location constraint defines a relative location of the cell relative to other cells.

5. The method of claim 1, wherein moving a cell comprises at least one of:
moving a cell in response to input from a user; and
moving a cell automatically.

6. The method of claim 1, wherein the location constraint defines a position of the cell in a geometric shape.

7. The method of claim 6, wherein the location constraint defines the position of the cell relative to an identified cell in the geometric shape.

8. The method of claim 7,
wherein the identified cell is a clock source; and
wherein the timing constraint defines a relative clock skew between the clock source and each of the other cells.

9. The method of claim 8, wherein the geometric shape comprises at least one of a star shape, a box shape, a cross shape, and a line shape.

10. The method of claim 8, wherein the geometric shape comprises an asymmetric shape.

11. The method of claim 1, wherein the location constraint defines a relative location of each of the plurality of cells relative to an identified cell.

12. The method of claim 11, wherein the one cell is a clock source, and the timing constraint defines a relative clock skew between the clock source and each of the plurality of cells.

13. A method of modifying a design of an integrated circuit, the method comprising:
assigning a set of properties to a signal source and a plurality of signal receivers, wherein the set of properties comprises:
a distance between the signal source and the plurality of signal receivers;
a distance between each of the plurality of signal receivers; and
a geometric shape defining an initial relative placement of the signal source and the plurality of signal receivers;
moving at least one of the signal source and the plurality of signal receivers to modify the initial relative placement;
automatically moving the remaining cells in accordance with the set of properties to restore the initial relative placement; and
generating the modified integrated circuit design responsive to the automatic cell movement.

14. The method of claim 13, wherein the signal source is a clock source and the signal receivers are clock receivers.

15. The method of claim 13, wherein the geometric shape comprises at least one of a star shape, a box shape, a cross shape, and a line shape.

16. A computer program product comprising a computer readable medium embodying a computer readable program for modifying a design of an integrated circuit, wherein the computer readable program when executed on a computer causes the computer to perform the steps of: assigning a set of properties to each of a plurality of cells of the integrated circuit, wherein the set of properties comprises:
a location constraint; and
a timing constraint;
moving a cell;
indicating which other cells in the plurality of cells are no longer in compliance with the set of properties;
moving the indicated cells to restore compliance with the set of properties; and
generating the modified integrated circuit design responsive to the movement of the cells.

17. The program product of claim 16, wherein moving the indicated cells is performed automatically.

18. The program product of claim 16, wherein assigning the set of properties further includes assigning a group identifier.

19. The program product of claim 16, wherein the location constraint defines a relative location of the cell relative to other cells.

20. The program product of claim 16, wherein moving a cell comprises at least one of:
moving a cell in response to input from a user; and
moving a cell automatically.

21. The program product of claim 16, wherein the location constraint defines a position of the cell in a geometric shape.

22. The program product of claim 21, wherein the location constraint defines the position of the cell relative to an identified cell in the geometric shape.

23. The program product of claim 23,
wherein the identified cell is a clock source; and
wherein the timing constraint defines a relative clock skew between the clock source and each of the other cells.

24. The program product of claim 23, wherein the geometric shape comprises at least one of a star shape, a box shape, a cross shape, and a line shape.

25. The program product of claim 23, wherein the geometric shape comprises an asymmetric shape.

26. The program product of claim 16, wherein the location constraint defines a relative location of each of the plurality of cells relative to an identified cell.

27. The program product of claim 26, wherein the one cell is a clock source, and the timing constraint defines a relative clock skew between the clock source and each of the plurality of cells.
